(19) United States
(12) Patent Application Publication
(10) Pub. No.: US 2011/0126932 A1
(43) Pub. Date: Jun. 2, 2011

(54) Faucet device

(75) Inventor: Chao-Kuang Chan, Taichung (TW)

(73) Assignee: Aquasys Technologies, Inc.

(21) Appl. No.: 12/592,521

(22) Filed: Nov. 27, 2009

(51) Int. Cl. F16K 51/00

(52) U.S. Cl. 137/801

(57) ABSTRACT

A faucet device includes a spout hub engaged in a housing and having an upper aperture and a lower bore separated from each other with a partition, and having an outlet port and an inlet port communicative with the bore and the aperture of the spout hub respectively for allowing the water to flow from the bore through the outlet port and the inlet port and into the aperture of the spout hub, a valve element rotatably attached to the housing for selectively blocking the inlet port and the outlet port of the spout hub and having a space for selectively communicating the inlet port and the outlet port of the spout hub with each other, and a faucet spout engaged into the housing and the spout hub for receiving the water from the spout hub.

### BACKGROUND OF THE INVENTION

1. Field of the Invention

The present invention relates to a faucet device, and more particularly to a faucet device including a simplified and solid structure for allowing the faucet device to be easily and quickly manufactured with a mass production and for preventing the water leaking from being generated in the faucet device.

2. Description of the Prior Art

Typical faucet devices comprise a spout hub attached to a base or escutcheon with one or more fasteners or lock nuts, a spout attached to the spout hub for allowing the water to flow out of the spout, and one or more handles attached to the base or escutcheon and connected to the spout hub or the spout and used to control the water flowing from two inlet conduits, through water pipes, and then into a central chamber in the spout hub.

For example, U.S. Pat. No. 6,062,249 to Givler discloses one of the typical faucet side spray diverters to be mounted within a portion of a water faucet assembly for controlling water flow to either a faucet spout or a spray discharge.

However, normally, a complicated diverter or valve device is required to be provided and manufactured and engaged into the spout hub for controlling the water to flow from the inlet conduits, through water pipes, and then into the central chamber in the spout hub, and a water leaking problem will have a great change to be generated in the faucet device, or between the spout hub and the valve device.

U.S. Pat. No. 6,182,682 to Chen, U.S. Pat. No. 6,302,135 to Chung, and U.S. Pat. No. 6,412,513 to Yang disclose the other typical valve devices for the faucet assemblies each also comprising a complicated valve device that is required to be provided and manufactured and engaged into the spout hub for controlling the water to flow from the inlet conduits, through water pipes, and then into the central chamber in the spout hub, and a water leaking problem will also have a great change to be generated in the faucet device, or between the spout hub and the valve device.

U.S. Pat. No. 6,470,906 to Shieh discloses a further typical valve device for the faucet assembly also comprising a complicated valve device that is required to be provided and manufactured and engaged into the spout hub for controlling the water to flow from the inlet conduits, through water pipes, and then into the central chamber in the spout hub, and a water leaking problem will also have a great change to be generated in the faucet device, or between the spout hub and the valve device.

The present invention has arisen to mitigate and/or obviate the afore-described disadvantages of the conventional valve control devices for faucet assemblies.

### SUMMARY OF THE INVENTION

The primary objective of the present invention is to provide a faucet device including a simplified and solid structure for allowing the faucet device to be easily and quickly manufactured with a mass production and for preventing the water leaking from being generated in the faucet device.

In accordance with one aspect of the invention, there is provided a faucet device comprising a housing including a chamber formed therein, and including an orifice formed in an upper wall thereof and communicative with the chamber of the housing, and including a compartment formed therein, a spout hub received and engaged into the chamber of the housing and including an aperture formed in an upper portion thereof and aligned with the orifice of the housing, and including a bore formed in a lower portion thereof, and including a partition formed therein and located between the aperture and the bore of the spout hub for separating the aperture and the bore of the spout hub from each other, and including an outlet port formed therein and communicative with the bore of the spout hub, and an inlet port formed therein and communicative with the aperture of the spout hub for allowing a water to flow from the bore through the outlet port of the spout hub and through the inlet port and into the aperture of the spout hub, a valve element rotatably received and engaged into the compartment of the housing for engaging with the spout hub and for selectively blocking the inlet port and the outlet port of the spout hub, and including a space formed therein for selectively communicating the inlet port and the outlet port of the spout hub with each other and for allowing the water to flow from the bore through the outlet port of the spout hub and then through the inlet port and into the upper aperture of the spout hub, and a faucet spout includes a lower portion engaged into the orifice of the housing and engaged into the aperture of the spout hub for receiving the water from the aperture of the spout hub, and the faucet device includes a simplified and solid structure for allowing the faucet device to be easily and quickly manufactured with a mass production and for preventing the water leaking from being generated in the faucet device.

The housing includes a port neck laterally extended outwardly therefrom and having the compartment formed in the port neck and communicative with the chamber of the housing for rotatably receiving and engaging with the valve element and for attaching the valve element to the housing.

The valve element includes a handle attached to an outer portion of the valve element for rotating the valve element relative to the housing and the spout hub and for controlling the water to flow from the bore through the outlet port of the spout hub and then through the inlet port and into the upper aperture of the spout hub and to flow out of the faucet spout.

The valve element includes a cover attached to the outer portion of the valve element, and the handle is attached and secured to the cover and the outer portion of the valve element for rotating the cover and the valve element relative to the housing and the spout hub.

The spout hub includes a tubular member extended downwardly therefrom and having the bore formed in the tubular member, and a fastener engaged and mounted onto the tubular member of the spout hub for attaching or mounting or securing the spout hub and the housing to the basin or the bathtub or other support members with one or more washers and one or more fasteners or lock nuts, and the tubular member of the spout hub is provided for attaching or mounting or coupling to a water reservoir with a hose in order to receive or obtain the water from the water reservoir.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a faucet device in accordance with the present invention, in which a portion of the faucet device has been cut off or removed for showing the inner structure of the faucet device;

FIG. 2 is an exploded view of the faucet device;

FIG. 3 is a partial perspective view illustrating a central faucet body member of the faucet device;

FIG. 4 is a partial cross sectional view of the faucet device taken along lines 4-4 of FIG. 1;

FIG. 5 is an enlarged partial cross sectional view of the faucet device; and

FIG. 6 is a partial cross sectional view of the faucet device taken along lines 6-6 of FIG. 5.

### DETAILED DESCRIPTION OF THE PREFERRED EMBODIMENT

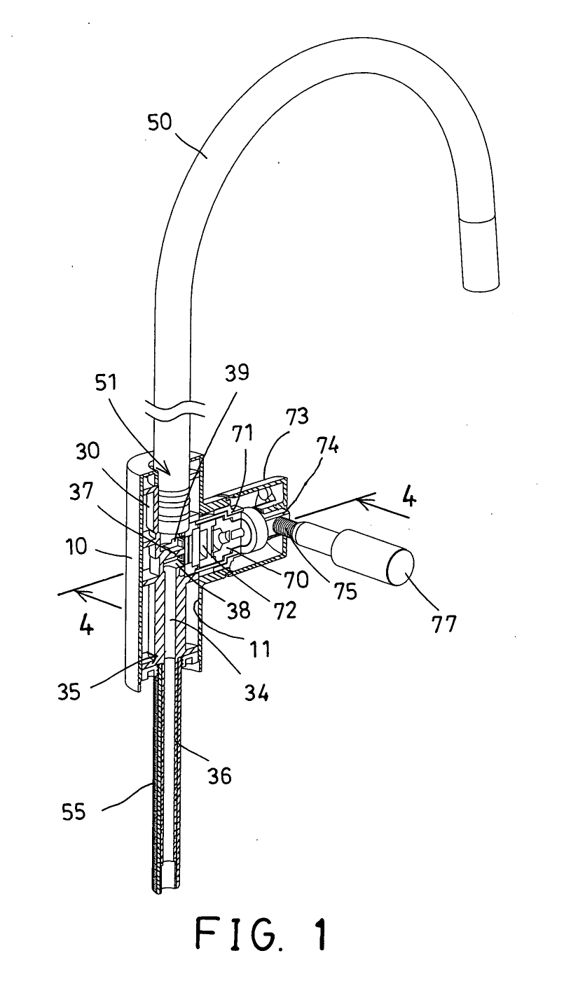

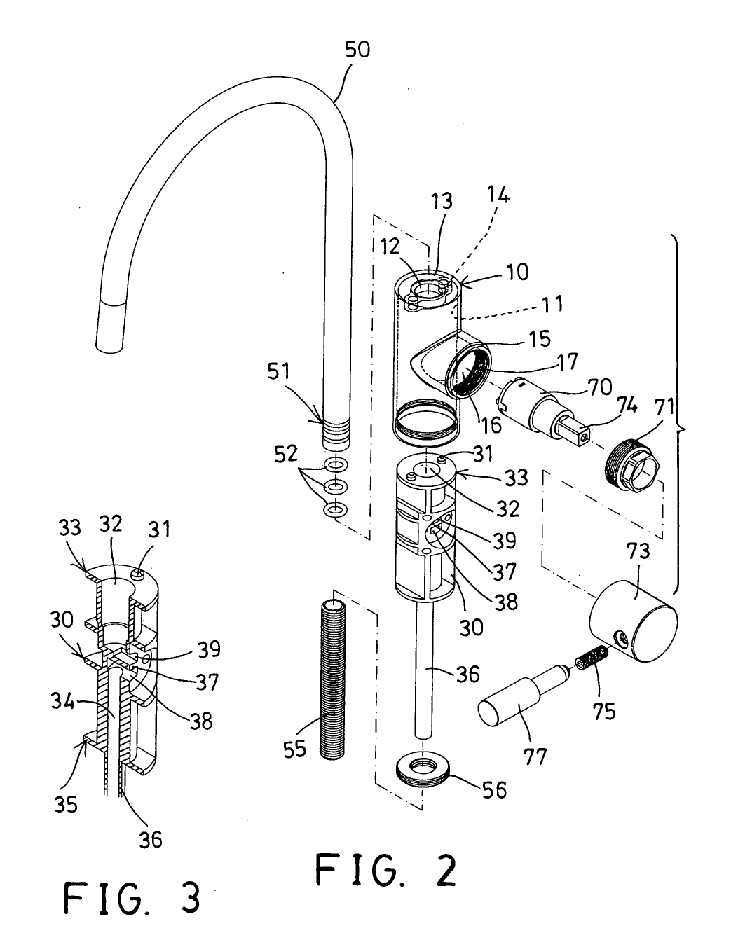

Referring to the drawings, and initially to FIGS. 1-4, a faucet device in accordance with the present invention comprises an outer housing 10 including a chamber 11 formed therein, and including an orifice 12 formed in an upper wall 13 thereof and communicative with the chamber 11 of the housing 10, and including one or more (such as two) cavities 14 formed therein, such as formed in the inner portion of the upper wall 13 and also communicative with the chamber 11 of the housing 10, and including a port neck 15 laterally extended outwardly therefrom and having a compartment 16 formed in the port neck 15 and also communicative with the chamber 11 of the housing 10 and having an inner thread 17 formed in the port neck 15.

A central faucet body member or spout hub 30 is received or engaged into the chamber 11 of the housing 10, and includes one or more (such as two) projections 31 extended outwardly or upwardly therefrom and engaged with the cavities 14 of the housing 10 for anchoring and positioning the spout hub 30 to the housing 10 and for preventing the spout hub 30 from being rotated relative to the housing 10, and includes an aperture 32 formed in the upper portion 33 thereof and aligned with the orifice 12 of the housing 10, and includes a bore 34 formed in the lower portion 35 thereof, and further includes a tubular member 36 extended downwardly therefrom and having the bore 34 also formed in the tubular member 36.

The spout hub 30 further comprises a partition 37 provided therein, such as formed in the middle portion of the spout hub 30 and located between the upper aperture 32 and the lower bore 34 of the spout hub 30 for separating the upper aperture 32 and the lower bore 34 of the spout hub 30 from each other, and further includes an outlet port 38 laterally formed therein and communicative with the lower bore 34 of the spout hub 30, and an inlet port 39 laterally formed therein and communicative with the upper aperture 32 of the spout hub 30 for allowing the water to flow from the water reservoir (not shown) or from the lower bore 34 through the outlet port 38 of the spout hub 30, and then through the inlet port 39 and into the upper aperture 32 of the spout hub 30.

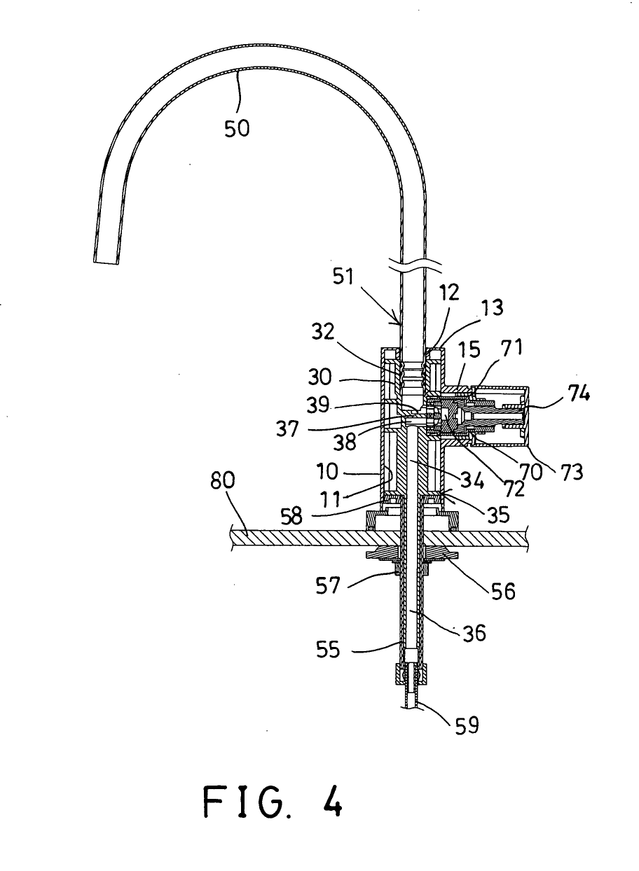

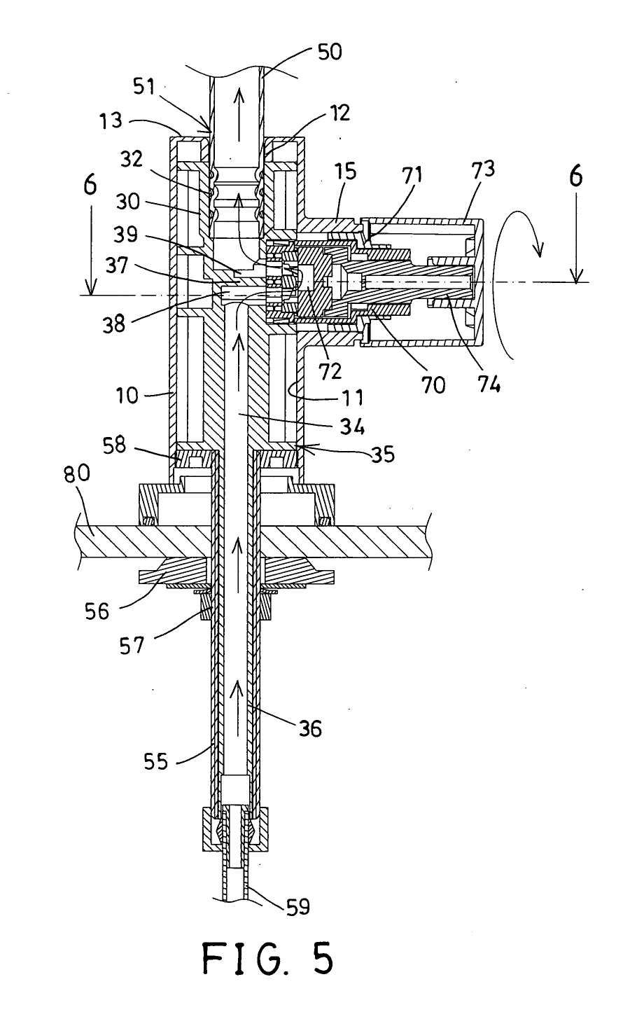

A faucet spout 50 includes a lower portion 51 engaged into the orifice 12 of the housing 10 and engaged into the aperture 32 of the spout hub 30 for receiving the water from the aperture 32 of the spout hub 30, and includes one or more sealing rings 52 disposed and engaged between the spout hub 30 and the faucet spout 50 for making a water tight seal between the spout hub 30 and the faucet spout 50, and a screw tube or fastener 55 is engaged or attached or mounted onto the tubular member 36 of the spout hub 30 for attaching or mounting or securing the spout hub 30 and the housing 10 to the basin 80, or the bathtub or other support members 80 (FIGS. 4, 5) with one or more washers 56 and one or more fasteners or lock nuts 57, 58, and the tubular member 36 of the spout hub 30 is provided for attaching or mounting or coupling to the water reservoir (not shown) with a hose 59 in order to receive the water from the water reservoir.

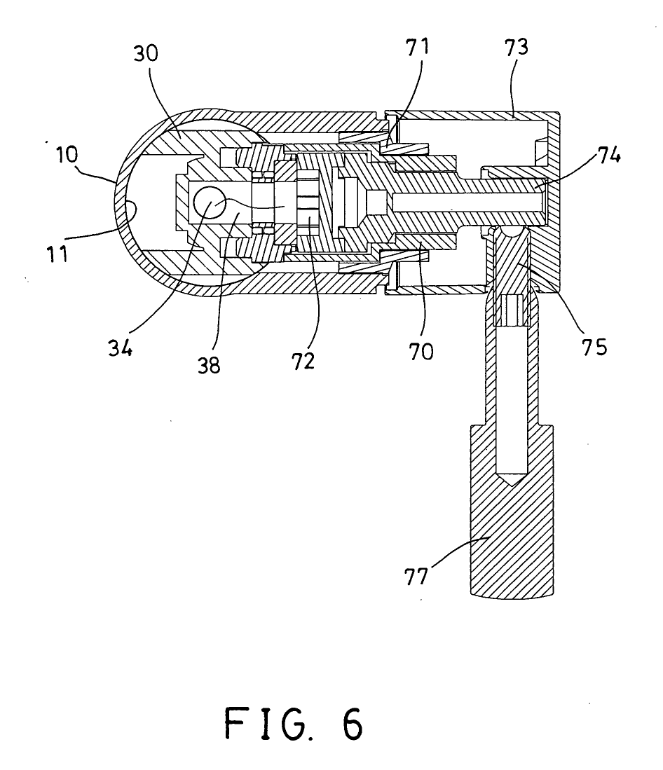

A valve element 70 is pivotally or rotatably received or engaged into the compartment 16 of the port neck 15 of the housing 10 and attached or mounted or secured to the port neck 15 of the housing 10 with a lock nut 71 which is threaded or engaged with the inner thread of the port neck 15 or of the housing 10 for allowing the valve element 70 to be pivotally or rotatably and stably or solidly retained in the compartment 16 of the port neck 15 of the housing 10, the valve element 70 is provided for engaging with the spout hub 30 and for selectively blocking or sealing or closing the inlet port 39 and the outlet port 38 of the spout hub 30, and includes a space 72 formed therein (FIGS. 1, 4-6) for selectively communicating the inlet port 39 and the outlet port 38 of the spout hub 30 with each other, and thus for allowing the water to flow from the lower bore 34 through the outlet port 38 of the spout hub 30, and then through the inlet port 39 and into the upper aperture 32 of the spout hub 30, best shown in FIGS. 5-6.

The faucet device in accordance with the present invention may further comprise a cover 73 engaged or attached or mounted onto the outer portion 74 of the valve element 70 for pivoting or rotating the valve element 70 relative to the housing 10 and the spout hub 30 in order to actuate the valve element 70 to selectively block or seal or close the inlet port 39 and the outlet port 38 of the spout hub 30, and to selectively communicate the inlet port 39 and the outlet port 38 of the spout hub 30 with each other and with the space 72 of the valve element 70. A handle 77 may be attached or mounted or secured to the outer portion 74 of the valve element 70 or secured to the cover 73 with one or more fasteners 75 for easily pivoting or rotating the valve element 70 relative to the housing 10 and the spout hub 30.

In operation, as shown in FIGS. 5 and 6, when the valve element 70 is rotated relative to the housing 10 and the spout hub 30, the space 72 of the valve element 70 may be actuated or operated to selectively communicate the inlet port 39 and the outlet port 38 of the spout hub 30 with each other, and thus for allowing the water to flow from the lower bore 34 through the outlet port 38 of the spout hub 30, and then through the inlet port 39 and into the upper aperture 32 of the spout hub 30. Alternatively, as shown in FIG. 1, the space 72 of the valve element 70 may also be actuated or operated to be selectively disengaged or offset from the inlet port 39 and the outlet port 38 of the spout hub 30 in order to actuate the valve element 70 to selectively block or seal or close the inlet port 39 and the outlet port 38 of the spout hub 30.

It is to be noted that the spout hub 30 includes a partition 37 solidly and integrally formed and provided therein, and there is only a valve element 70 required to be provided and engaged with the spout hub 30 for selectively blocking or sealing or closing or opening or communicating the inlet port 39 and the outlet port 38 of the spout hub 30 with each other in order to control the water to flow from the lower bore 34 through the outlet port 38 of the spout hub 30, and then through the inlet port 39 and into the upper aperture 32 of the spout hub 30, and then to selectively flow out through the faucet spout 50.

Accordingly, the faucet device in accordance with the present invention includes a simplified and solid structure for allowing the faucet device to be easily and quickly manufactured with a mass production and for preventing the water leaking from being generated in the faucet device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A faucet device comprising:
a housing including a chamber formed therein, and including an orifice formed in an upper wall thereof and communicative with said chamber of said housing, and including a compartment formed therein,
a spout hub received and engaged into said chamber of said housing and including an aperture formed in an upper portion thereof and aligned with said orifice of said housing, and including a bore formed in a lower portion thereof, and including a partition formed therein and located between said aperture and said bore of said spout hub for separating said aperture and said bore of said spout hub from each other, and including an outlet port formed therein and communicative with said bore of said spout hub, and an inlet port formed therein and communicative with said aperture of said spout hub for allowing a water to flow from said bore through said outlet port of said spout hub and through said inlet port and into said aperture of said spout hub,
a valve element rotatably received and engaged into said compartment of said housing for engaging with said spout hub and for selectively blocking said inlet port and said outlet port of said spout hub, and including a space formed therein for selectively communicating said inlet port and said outlet port of said spout hub with each other and for allowing the water to flow from said bore through said outlet port of said spout hub and then through said inlet port and into said upper aperture of said spout hub, and
a faucet spout includes a lower portion engaged into said orifice of said housing and engaged into said aperture of said spout hub for receiving the water from said aperture of said spout hub.

2. The faucet device as claimed in claim 1, wherein said housing includes a port neck laterally extended outwardly therefrom and having said compartment formed in said port neck and communicative with said chamber of said housing.

3. The faucet device as claimed in claim 1, wherein said valve element includes a handle attached to an outer portion of said valve element for rotating said valve element relative to said housing and said spout hub.

4. The faucet device as claimed in claim 3, wherein said valve element includes a cover attached to said outer portion of said valve element, and said handle is attached and secured to said cover and said outer portion of said valve element.

5. The faucet device as claimed in claim 1, wherein said spout hub includes a tubular member extended downwardly therefrom and having said bore formed in said tubular member, and a fastener engaged and mounted onto said tubular member of said spout hub.
